(19) United States
(12) Patent Application Publication
(10) Pub. No.: US 2025/0050219 A1
(43) Pub. Date: Feb. 13, 2025

(54) Customized Interactive Media

(71) Applicant: Christopher Kessler, Perrysburg, OH (US)

(72) Inventor: Christopher Kessler, Perrysburg, OH (US)

(21) Appl. No.: 18/799,457

(22) Filed: Aug. 9, 2024

Related U.S. Application Data
(60) Provisional application No. 63/519,053, filed on Aug. 11, 2023.

(51) Int. Cl. A63F 13/60; A63F 13/79; G06F 3/0484

(52) U.S. Cl. CPC A63F 13/60; A63F 13/79; G06F 3/0484

(57) ABSTRACT

Systems, apparatuses, and methods for creating customized interactive media are provided. The system includes at least one processor in communication with at least one database, a memory device including readable instructions, and a user device in communication with the at least one processor via a network connection. An interactive media application and a graphical user interface of that application, which may be executed on the user device, arranges graphical depictions and data in a manner designed to allow a user to create a customized interactive media experience for an end user.

### CROSS-REFERENCE TO RELATED APPLICATION

This application claims the benefit of U.S. Provisional Patent Application Ser. No. 63/519,053, filed Aug. 11, 2023, the entirety of which is herein incorporated by reference.

### FIELD

The present disclosure relates generally to the field of interactive media, and more particularly to an interactive media application and a graphical user interface of that application that arranges graphical depictions and data in a manner designed to allow a user thereof to create a customized interactive media experience for an end user.

### BACKGROUND

Over time, interactive media, for example video games, has become increasingly more popular with adults than just the tradition adolescent user. Of the 214 million users in the United States, 51 million are adolescent users while 163 million are adults. The millennial generation who grew up with interactive media has now become parents themselves and see significant value in its use. For example, a majority of parents believe interactive media can be educational, while still providing entertainment in family time. Thus, the general public and more users are recognizing the benefits of using interactive media in different aspects of daily life.

Accordingly, it would be desirable to provide an interactive media application and a graphical user interface of that application that receives input data in a manner designed to allow a user thereof to create a customized interactive media experience for an end user.

### BRIEF SUMMARY

In concordance and agreement with the presently described subject matter, an interactive media application and a graphical user interface of that application that receives input data in a manner designed to allow a user thereof to create a customized interactive media experience for an end user, has been newly designed.

In one embodiment, A system for customizing interactive media using a graphical user interface, comprises: a computing system with at least one processing device and at least one memory device, wherein the computing system executes computer-readable instructions; and a network connection operatively connecting at least one user device and the computing system, the network connection configured to permit network data flow between the at least one user device and the computing system; wherein, upon execution of the computer-readable instructions, the computing system is configured to: provide, via a graphical user interface of the at least one user device, an interactive media application to a user for installation on the at least one user device, wherein the at least one user device is configured to wirelessly communicate with the computing system via the interactive media application; receive, via the graphical user interface of the at least one user device, input data to generate a customized end user specific interactive media for an end user; generate, via the at least one processing device, the customized end user specific interactive media for the end user; and display, via the interactive media application, the customized end user specific interactive media on a graphical user interface of an end user device.

In another embodiment, a method for customizing an interactive media, comprises: providing a computing system with at least one processing device and at least one memory device, wherein the computing system executes computer-readable instructions, and a network connection operatively connecting at least one user device and the computing system, the network connection configured to permit network data flow between the at least one user device and the computing system, and wherein the at least one user device is configured to wirelessly communicate with the computing system via an interactive media application; receiving input data related to an end user, via a graphical user interface of the at least one user device and the interactive media application; generating a customized end user specific interactive media based upon the input data; and displaying the customized end user specific interactive media on a graphical user interface of at least one end user device.

In yet another embodiment, a method for customizing an interactive media, comprises: displaying at least one query related to personal data of an end user on a graphical user interface of a user device; receiving input data related to the personal data of the end user via the graphical user interface of the user device; displaying at least one query related to an end user specific interactive media experience on the graphical user interface of the user device; receiving input data related to the end user specific interactive media experience via the graphical user interface of the user device; displaying at least one query related to an end user specific occasion and/or event on the graphical user interface of the user device; receiving input data related to the end user specific occasion and/or event via the graphical user interface of the user device; displaying at least one query related to an end user specific theme on the graphical user interface of the user device; receiving input data related to the end user specific theme via the graphical user interface of the user device; displaying at least one query related to one or more end user specific characters on the graphical user interface of the user device; receiving input data related to the one or more end user specific characters via the graphical user interface of the user device; displaying at least one query related to one or more end user specific challenges on the graphical user interface of the user device; receiving input data related to the one or more end user specific challenges via the graphical user interface of the user device; generating, via at least one processing device of a computing system, a customized end user specific interactive media based upon the input data received; and displaying the customized end user specific interactive media on a graphical user interface of at least one end user device.

As aspects of some embodiments, upon execution of the computer-readable instructions, the computing system is further configured to: generate a predictive model during training of a machine learning program including a neural network of the machine learning program, wherein a training data set utilized during the training of the machine learning program comprises an input data set of at least one user, and wherein the input data set of the at least one user includes at least one data entry related to interactive media; predict, by the predictive model, at least one predicted input data of the at least one user based upon the input data set of the at least one user; and generate the customized end user specific interactive media for the end user based upon the at least one predicted input data.

As aspects of some embodiments, upon execution of the computer-readable instructions, the computing system is further configured to transmit an end user specific access code to the at least one user device.

As aspects of some embodiments, upon execution of the computer-readable instructions, the computing system is further configured to: provide, via the graphical user interface of the end user device, the interactive media application to the end user for installation on the end user device; and receive, via the graphical user interface of the end user device, the end user specific access code for the customized end user specific interactive media.

As aspects of some embodiments, upon execution of the computer-readable instructions, the computing system is further configured to receive, via the graphical user interface of the end user device, input control from the end user of one or more characters of the customized end user specific interactive media.

As aspects of some embodiments, upon execution of the computer-readable instructions, the computing system is further configured to receive, via the at least one user device, personal information of the at least one user to complete a payment transaction.

As aspects of some embodiments, the input data is related to personal information of the end user.

As aspects of some embodiments, the personal information of the end user includes a name, an age, an age range, a capability, a difficulty level, a gender, at least one favorite color, at least one favorite character, at least one interest, and/or at least one activity of the end user.

As aspects of some embodiments, the input data is related to features of an interactive media experience of the end user.

As aspects of some embodiments, the features of the interactive media experience includes a welcome message, a commencement message, a victory message, a conclusion message, and/or one or more rewards.

As aspects of some embodiments, the one or more rewards correspond to a transfer of one or more actual items from the user to the end user.

As aspects of some embodiments, the input data is related to features of an occasion and/or event of the customized end user specific interactive media.

As aspects of some embodiments, the features of the occasion and/or event includes a birthday, a graduation, an anniversary, a religious holiday, a baby shower, a wedding shower, and/or a wedding engagement.

As aspects of some embodiments, the input data is related to features of a theme of the customized end user specific interactive media.

As aspects of some embodiments, the input data is related to features of at least one character of the customized end user specific interactive media.

As aspects of some embodiments, the input data is related to one or more challenges for the end user within the customized end user specific interactive media.

As aspects of some embodiments, the challenges have various levels of complexity and difficulty.

As aspects of some embodiments, the customized end user specific interactive media is a greeting card-like video game experience.

The features, functions, and advantages that have been discussed may be achieved independently in various embodiments of the present disclosure or may be combined in yet other embodiments, further details of which can be seen with reference to the following description and drawings, along with the appended claims.

### BRIEF DESCRIPTION OF THE DRAWINGS

The drawings described herein are for illustrative purposes only of selected embodiments and not all possible implementations, and are not intended to limit the scope of the present disclosure.

FIG. 1 illustrates a host system, and environment thereof, including a centralized server system, distributed computers and mobile devices, and communication therebetween, according to at least one embodiment of the present disclosure;

FIGS. 2-9 are exemplary illustrations of a display of a computing device executing an interactive media application according to an embodiment of the present disclosure; and

FIG. 10 is a flowchart diagram of a method for customizing interactive media using an interactive media application according to an embodiment of the present disclosure.

### DETAILED DESCRIPTION OF EMBODIMENTS

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

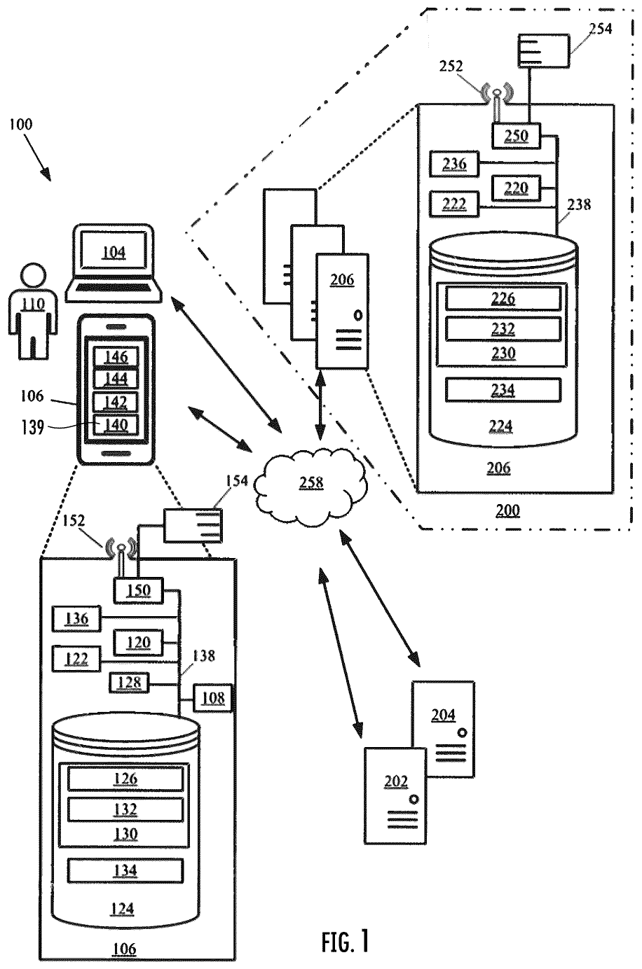

FIG. 1 illustrates a system 100 and environment thereof, including centralized and distributed computing devices, according to at least one embodiment, by which a user 110 benefits through use of services and products of a host system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which an interactive media application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser applications. These applications also typically provide a graphical user interface 139 (also referred herein “GUI”) on a display 140 (e.g., a liquid crystal display or the like), which can be, as a non-limiting example, a touch screen of the mobile device 106 that allows the user 110 to communicate with, for example, an interactive media builder and/or other devices or systems. In one embodiment, when the user 110 decides to enroll in an interactive media builder program, the user 110 downloads or otherwise obtains the interactive media application 132 from a host system, for example host system 200, or from a distinct application server. In other embodiments, the user 110 interacts with an interactive media builder via a web browser application in addition to, or instead of, the interactive media application 132.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, user preferences, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include the display 140, for example, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the host system 200, and at least some outputs in such examples correspond to data representing host-side actions and communications in two-way communications between a user 110 and a host system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The host system 200 can offer any number or type of services and products to one or more users 110. In some examples, the host system 200 offers products. In some examples, the host system 200 offers services. Use of “service(s)” or “product(s)” thus relates to either or both in these descriptions. With regard, for example, to online information and interactive media services, “service” and “product” are sometimes termed interchangeably. In non-limiting examples, services and products include interactive media services and products, information services and products, custom services and products, predefined or pre-offered services and products, internet products and services, and social media, which may include, in non-limiting examples, services and products relating to customized interactive media.

To provide access to, or information regarding, some or all the services and products of the host system 200, automated assistance may be provided by the host system 200. For example, automated access to user accounts and replies to inquiries may be provided by host-side automated voice, text, and graphical display communications and interactions.

A computing system 206 of the host system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the mobile device 104 and computing device 106, and the host computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include a host or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are illustrated in FIG. 1, representing any number and variety of data sources, users, consumers, customers, business entities, clubs, and groups of any size are all within the scope of the descriptions. In at least one example, the external systems 202, 204 represent computing devices of end users (e.g., recipients) of the customized interactive media. In another example, the external systems 202, 204 represent third party systems configured to interact with the user devices 104, 106 and/or the host system 200 in back-end transactions. With regard, for example, to the interactive media application 132, “end user” and “recipient” are sometimes termed interchangeably.

In certain embodiments, one or more of the systems such as the user devices 104, 106, the host system 200, and/or the external systems 202, 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

One type of algorithm suitable for use in machine learning modules as described herein is an artificial neural network or neural network, taking inspiration from biological neural networks. An artificial neural network can, in a sense, learn to perform tasks by processing examples, without being programmed with any task-specific rules. A neural network generally includes connected units, neurons, or nodes (e.g., connected by synapses) and may allow for the machine learning program to improve performance. A neural network may define a network of functions, which have a graphical relationship. As an example, a feedforward network may be utilized, e.g., an acyclic graph with nodes arranged in layers.

Having described a host computing environment as might be used by an interactive media builder, and general characteristics of systems which may be employed in the host computing environment, attention is now turned to the topic of the interactive media application 132 and the graphical user interface 139 thereof that is designed to promote a user's experience in connection with the interactive media application 132 and arranges graphical depictions and data in a manner designed to allow a user thereof to create a customized interactive media experience for an end user.

Customized interactive media may be tailored for each specific end user and/or occasion while offering a novel and interactive experience of the end user for certain occasions or events, including birthdays, holidays, or various other days of special meaning. The interactive media application 132 and the graphical user interface 139 of the interactive media application 132 empowers the user 110 to quickly create customized and personalized interactive media without any specialized knowledge. For example, the interactive media application 132 may permit the user 110 to set preferences for the end user such as characters (e.g., heroes, villains, enemies, etc.), rewards collected, level themes and locations, major prizes and trophies, puzzles and challenges, bosses, welcome messages at commencement of the interactive media, end or victory messages at conclusion of the interactive media, and the like.

In certain embodiments, the user 110 uses either the computing device 104 or the mobile device 106 to access the host system 200, where the computing device 104 executes a web browser application in which the graphical user interface 139 of the interactive media application 132 is displayed. The computing device 104 and/or the mobile device 106 communicate with the computing system (back-end servers) 206 via the network (“cloud”) 258.

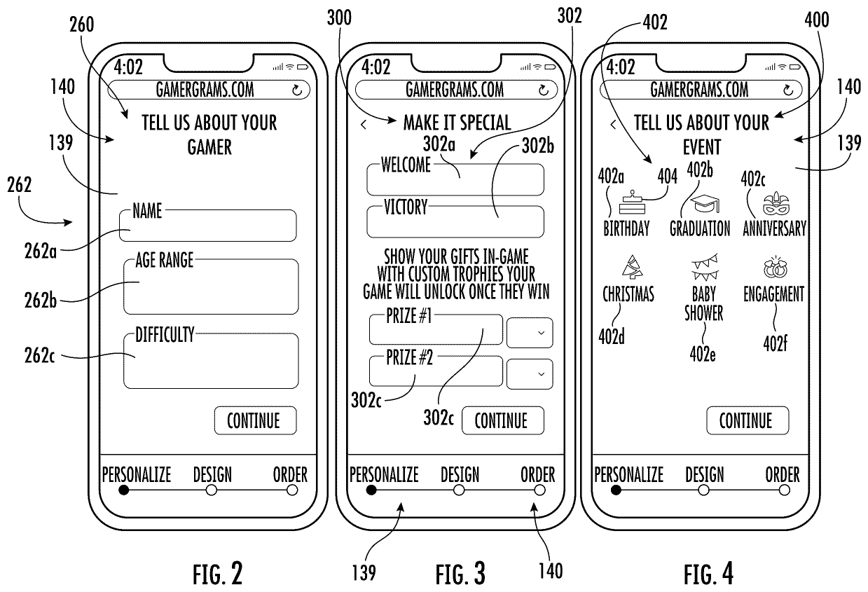

FIGS. 2-9 are exemplary illustrations of the display 140 of a mobile device 106 running the interactive media application 132, depicting a customization process overview including various data queries, displays and preferences related to an end user (e.g., recipient) for a particular account of a user, according to an embodiment of the present disclosure.

The display 140 of FIGS. 2-9 are depicted in a manner which generally corresponds with a mobile device 106, where, because of the smaller screen area of mobile devices (especially smart phones), the data displays may be distributed across multiple pages of the interactive media application 132. The user may navigate the pages using tabs at the top and/or bottom of the display 140, or other suitable techniques. It is understood that in other embodiments of the present disclosure, the interactive media application 132 executed by the computing device 104 may be configured to display the same information depicted in FIGS. 2-9; however, because of the larger screen area of the computing device 104 more information can be displayed simultaneously. Various means and methods may be employed to input data and information into the interactive media application 132.

Referring now to FIG. 2, an illustration of the display 140 showing exemplary queries 260 of the interactive media application 132 related to the end user is depicted. In one embodiment, the user 110 may be requested to input personal data 262 of the end user, for example, a name 262a, an age or age range 262b, and/or a capability or difficulty level 262c of the end user. It is understood that the interactive media application 132 may include displaying more or less queries 260 related to the end user as desired, such as one or more queries 260 related to gender, favorite colors and characters, interests, activities, and the like, for example. As illustrated, the personal data 262 of the end user may be inputted by the user 110 by various means, including but not limited to text entry, drop-down elements, and/or option selection (e.g. radio buttons, check boxes, etc.), for example. The computing system 206, and particularly the processing device 220, is configured to receive the personal data 262 of the end user which is inputted into the interactive media application 132 by the user 110.

FIG. 3 is an illustration of the display 140 showing additional exemplary queries 300 related to the end user. In certain embodiments, the user 110 may be requested to input data and information related to features and details of an end user specific interactive media experience 302. In some instances, the user 110 may be requested to input a welcome or commencement message 302a, a victory or conclusion message 302b, and rewards 302c (e.g., prizes, trophies or gifts) that the end user receives upon completion of the interactive media experience 302. In certain embodiments, the one or more rewards 302c may correspond to a transfer of one or more actual items (e.g., gifts) from the user to the end user. Similar to the personal data 262 of the end user, the input data related to the features and details of the end user specific interactive media experience 302 may be entered by various means, including but not limited to text entry, drop-down elements, and/or option selection, for example. The computing system 206, and particularly the processing device 220, is configured to receive the input data related to the end user specific interactive media experience 302 which is inputted into the interactive media application 132 by the user 110.

FIG. 4 is an illustration of the display 140 showing an exemplary query 400 related to an end user specific occasion and/or event 402. In certain embodiments, the user 110 may be requested to input data and information related to features and details of the end user specific occasion and/or event 402. The end user specific occasion and/or event 402 may be a birthday 402a, a graduation 402b, an anniversary 402c, a religious holiday 402d (e.g., Christmas), a baby shower 402e, a wedding shower, a wedding engagement 402e, and the like, for example. It is understood that other end user specific occasions and/or events 402 may be created and/or added to the interactive media application 132 by the user 110. In some instances, the user 110 may be requested to select the end user specific occasion and/or event 402 from a group of predetermined options. For example, the user 110 may be requested to select an icon 404 showing a cake to indicate that the end user specific occasion and/or event 402 is a birthday. Various other means and method to input data and information related to features and details of the end user specific occasion and/or event 402 into the interactive media application 132 may be employed. The computing system 206, and particularly the processing device 220, is configured to receive the input data related to the end user specific occasion and/or event 402 which is inputted into the interactive media application 132 by the user 110.

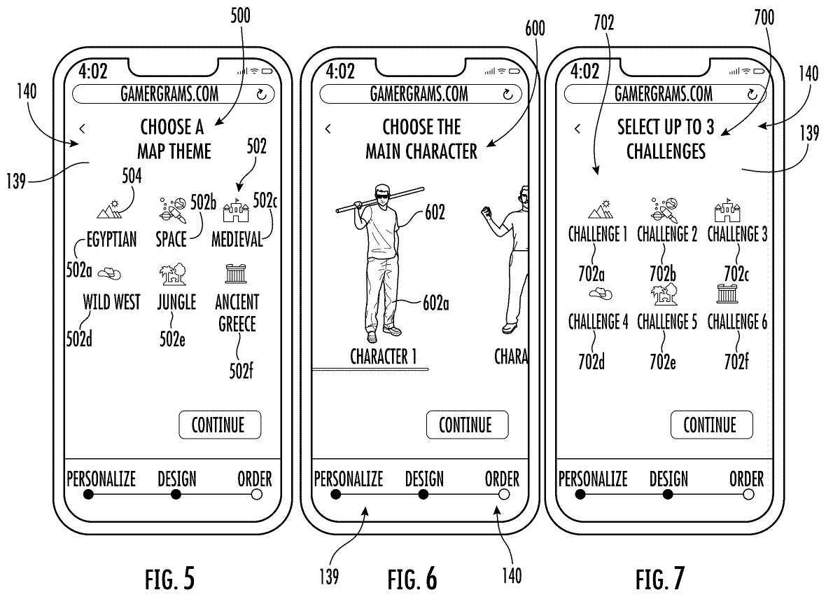

FIG. 5 is an illustration of the display 140 showing an exemplary query 500 related to an end user specific theme 502 for the interactive media. In certain embodiments, the user 110 may be requested to input data and information related to features and details of the end user specific theme 502 for the interactive media. The end user specific theme 502 may be Egyptian 502a, space 502b, medieval 502c, Wild West 502d, jungle 502e, ancient Greece 502f, and the like, for example. It is understood that other end user specific themes 502 may be created and/or added to the interactive media application 132 by the user 110. In some instances, the user 110 may be requested to select one or more themes from a group of predetermined options. For example, the user 110 may select an icon 504 showing pyramids to indicate an Egyptian theme. Various other means and method to input data and information related to features and details of the end user specific theme 502 into the interactive media application 132 may be employed. The computing system 206, and particularly the processing device 220, is configured to receive the input data related to the end user specific theme 502 for the interactive media which is inputted into the interactive media application 132 by the user 110.

FIG. 6 is an illustration of the display 140 showing an exemplary query 600 related to one or more end user specific characters 602 for the interactive media. In certain embodiments, the user 110 may be requested to input data and information related to features and details of the end user specific characters 602 for the interactive media. It is understood that other end user specific characters 602 may be created and/or added to the interactive media application 132 by the user 110. In some instances, the user 110 may be requested to select one or more characters 602 from a group of predetermined options. For example, the user 110 may be requested to select a main character 602a (e.g., a hero) and/or one or more supporting characters (e.g., villains or enemies). Abilities, difficulty levels, and/or designs of the characters 602 may be set by the user 110 in the interactive media application 132. Various other means and method to input data and information related to features and details of the end user specific characters 602 into the interactive media application 132 may be employed. The computing system 206, and particularly the processing device 220, is configured to receive the input data related to the end user specific characters 602 for the interactive media which is inputted into the interactive media application 132 by the user 110.

FIG. 7 is an illustration of the display 140 showing an exemplary query 700 related to one or more end user specific challenges 702 to be completed by the end user within the interactive media. In certain embodiments, the user 110 may be requested to input data and information related to features and details of the end user specific challenges 702 for the end user. Complexity and/or difficulty levels of the challenges 702 may be set by the user 110 in the interactive media application 132. It is understood that other end user specific challenges 702 may be created and/or added to the interactive media application 132 by the user 110. In some instances, the user 110 may be requested to select one or more end user specific challenges 702 from a group of options. For example, the user 110 may be requested to select a first challenge 702a, a second challenge 702b, a third challenge 702c, a fourth challenge 702d, a fifth challenge 702e, and a sixth challenge 702f to be completed consecutively by the end user. Various other means and method to input data and information related to features and details of the end user specific challenges 702 to be completed by the end user into the interactive media application 132 may be employed. The computing system 206, and particularly the processing device 220, is configured to receive the input data related to the end user specific challenges 702 which is inputted into the interactive media application 132 by the user 110.

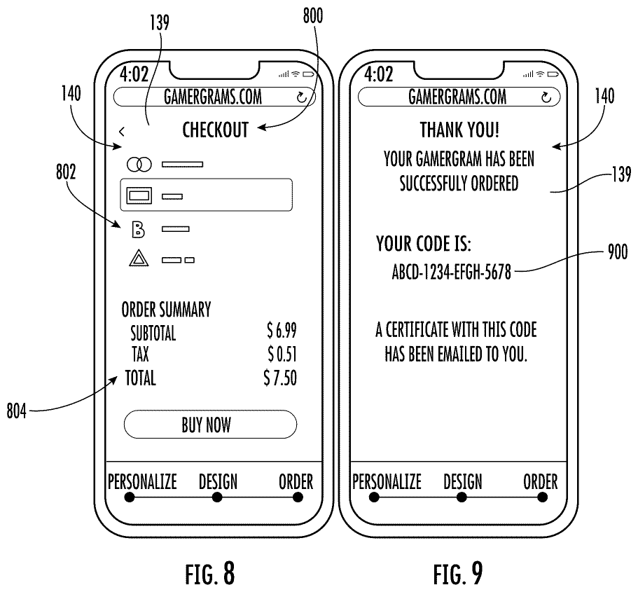

FIG. 8 is an illustration of the display 140 showing an exemplary payment methods 800 available to the user 110. In some embodiments, the interactive media application 132, via the computing device 104 or mobile device 106 of the user 110 and the network 258, may be in communication with one of the external systems 202, 204, which may be a third party payment provider 802 such as PayPal®, Apple Pay, and the like, for example. The user 110 may be requested to input personal identification information (PII) of the user 110 to complete a payment transaction 804. As illustrated in FIG. 9, once the payment transaction 804 is complete, the interactive media application 132 generates and provides to the user 110 an end user specific access code 900 for the customize interactive media to be shared with the end user. The end user may then experience the customized interactive media by downloading and executing the interactive media application 132 and inputting the end user-specific access code 900. The computing system 206, upon execution of the computer-readable instructions, is configured to receive, via the graphical user interface of the end user device, input control from the end user of one or more characters 602 of the customized end user specific interactive media.

In preferred embodiments, the customized interactive media may create a greeting card-like video game experience, wherein the end user receives a welcome message 302a from the user 110, completes a number of end user specific challenges 702 determined by the user 110, receives rewards 302c (i.e., representations of actual gifts to the end user by the user 110) upon completion of all of the end user specific challenges 702 and/or upon completion of each individual end user specific challenge 702, and receives a message 302b (e.g., a victory message) from the user 110 at the end. In some instances, the end user specific challenges 702 may be games and puzzles with various levels of complexity and difficulty. Yet, in other instances, the end user specific challenges 702 may be more like conventional video games, wherein the end user is the main character 602a that must complete certain tasks or defeat other characters to advance to another challenge and/or win the game.

It should be appreciated that any and all data inputted by the user 110 during the customization process of the interactive media including, but not limited to various preferences related to the user and/or the end user, user and/or end user profiles, and like, may be stored in the storage device 224 of the host system 200 for later access by the interactive media application 132.

In some embodiments, the interactive media application 132 may use artificial intelligence in various aspects of the customization process of the interactive media. At least a portion of the customized end user specific interactive media may be predicted customized interactive media as determined by the machine learning program as described hereinabove. An entirety of the customized end user specific interactive media may be predicted by the machine learning program if desired. In one non-limiting example, the interactive media application 132 may use artificial intelligence and the machine learning program to predict at least a portion (e.g., the theme 502, the characters 602, the challenges 702) of the end user specific interactive media based upon the personal data 262 of the end user inputted by the user 110. In another non-limiting example, the interactive media application 132 may use artificial intelligence and the machine learning program to predict at least a portion of the end user specific interactive media based upon the rewards 302c to be received by the end user. In yet another non-limiting example, the artificial intelligence and the machine learning program may predict the end user specific characters 602 in the interactive media. It should be appreciated that the use of artificial intelligence and machine learning program by the interactive media application 132 and the host system 200 is not limited.

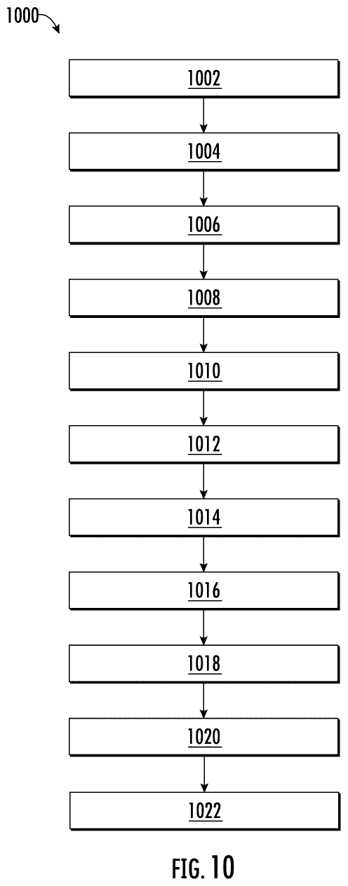

FIG. 10 is a flowchart diagram of a method 1000 for customizing the interactive media in the interactive media application 132 according to an embodiment of the present disclosure. At step 1002, data for an individual user 110 may be transmitted over the network 258 to the user device, referring to either or both of the computing device 104 and the mobile device 106, executing the interactive media application 132. At step 1004, the data for the user is displayed, for example as depicted in FIGS. 2-9. At step 1006, the user 110, via the graphical user interface 139, inputs personal data 262 of the end user. At step 1008, the user 110, via the graphical user interface 139, inputs data and information related to features and details of the interactive media experience 302 of the end user. At step 1010, the user 110, via the graphical user interface 139, inputs data and information related to features and details of the occasion and/or event 402. At step 1012, the user 110, via the graphical user interface 139, inputs data and information related to features and details of the theme 502 for the interactive media. At step 1014, the user 110, via the graphical user interface 139, inputs data and information related to features and details of the characters 602 for the interactive media. At step 1016, the user 110, via the graphical user interface 139, inputs data and information related to features and details of the challenges 702 for the end user. At step 1018, the user 110, via the graphical user interface 139, inputs personal identification information (PII) to complete a payment transaction 804. At step 1020, upon completion of the payment transaction 804, the interactive media application 132 generates an end user specific interactive media and, at step 1022, provides an end-user specific access code 900 for the customized end user specific interactive media to the user 110 to be shared with the end user. It is understood that the steps 1020 and 1022 may be performed substantially concurrently or consecutively, if desired.

It is to be understood that the method of FIG. 10, and the user interface and graphical display features shown on FIGS. 2-9, are programmed as one or more algorithm which runs on the computing system 206 (the host server) cooperatively and interoperably with the computing device 104 and/or the mobile device 106 of the user 110. For example, the computing device 104 or the mobile device 106 receives input from the user 110 in the form of mouse clicks and screen taps along with optional keyboard inputs, and provides the user inputs to the computing system 206 which delivers data back to the computing device 104 or the mobile device 106. Various other means and method of receiving input from the user 110 may be employed. These devices all include processors, memory and communication modules suitable to run the algorithm(s) and perform the graphical display in the manner described throughout the present disclosure.

The preceding discussion has been structured in terms of a single user and a single end user. It is to be understood that all of the users of the interactive media application 132 have access to the disclosed graphical user interface 139 features in the interactive media application 132, and that all of the account or profile data are correspondingly stored in relation to the appropriate user, the specific account(s) or end user associated with that user, the specific transactions within that account, etc., in a manner which would be understood by those familiar with database systems.

Particular embodiments and features of the disclosed methods and systems have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A system for customizing interactive media using a graphical user interface, comprising:
a computing system with at least one processing device and at least one memory device, wherein the computing system executes computer-readable instructions; and
a network connection operatively connecting at least one user device and the computing system, the network connection configured to permit network data flow between the at least one user device and the computing system;
wherein, upon execution of the computer-readable instructions, the computing system is configured to:
provide, via a graphical user interface of the at least one user device, an interactive media application to a user for installation on the at least one user device, wherein the at least one user device is configured to wirelessly communicate with the computing system via the interactive media application;
receive, via the graphical user interface of the at least one user device, input data to generate a customized end user specific interactive media for an end user;
generate, via the at least one processing device, the customized end user specific interactive media for the end user; and
display, via the interactive media application, the customized end user specific interactive media on a graphical user interface of an end user device.

2. The system of claim 1, wherein, upon execution of the computer-readable instructions, the computing system is further configured to:
generate a predictive model during training of a machine learning program including a neural network of the machine learning program, wherein a training data set utilized during the training of the machine learning program comprises an input data set of at least one user, and wherein the input data set of the at least one user includes at least one data entry related to interactive media;
predict, by the predictive model, at least one predicted input data of the at least one user based upon the input data set of the at least one user; and
generate the customized end user specific interactive media for the end user based upon the at least one predicted input data.

3. The system of claim 1, wherein, upon execution of the computer-readable instructions, the computing system is further configured to transmit an end user specific access code to the at least one user device.

4. The system of claim 3, wherein, upon execution of the computer-readable instructions, the computing system is further configured to:
provide, via the graphical user interface of the end user device, the interactive media application to the end user for installation on the end user device; and
receive, via the graphical user interface of the end user device, the end user specific access code for the customized end user specific interactive media.

5. The system of claim 1, wherein, upon execution of the computer-readable instructions, the computing system is further configured to receive, via the graphical user interface of the end user device, input control from the end user of one or more characters of the customized end user specific interactive media.

6. The system of claim 1, wherein, upon execution of the computer-readable instructions, the computing system is further configured to receive, via the at least one user device, personal information of the at least one user to complete a payment transaction.

7. The system of claim 1, wherein the input data is related to personal information of the end user.

8. The system of claim 7, wherein the personal information of the end user includes a name, an age, an age range, a capability, a difficulty level, a gender, at least one favorite color, at least one favorite character, at least one interest, and/or at least one activity of the end user.

9. The system of claim 1, wherein the input data is related to features of an interactive media experience of the end user.

10. The system of claim 9, wherein the features of the interactive media experience includes a welcome message, a commencement message, a victory message, a conclusion message, and/or one or more rewards.

11. The system of claim 10, wherein the one or more rewards correspond to a transfer of one or more actual items from the user to the end user.

12. The system of claim 1, wherein the input data is related to features of an occasion and/or event of the customized end user specific interactive media.

13. The system of claim 12, wherein the features of the occasion and/or event includes a birthday, a graduation, an anniversary, a religious holiday, a baby shower, a wedding shower, and/or a wedding engagement.

14. The system of claim 1, wherein the input data is related to features of a theme of the customized end user specific interactive media.

15. The system of claim 1, wherein the input data is related to features of at least one character of the customized end user specific interactive media.

16. The system of claim 1, wherein the input data is related to one or more challenges for the end user within the customized end user specific interactive media.

17. The system of claim 16, wherein the challenges have various levels of complexity and difficulty.

18. The system of claim 1, wherein the customized end user specific interactive media is a greeting card-like video game experience.

19. A method for customizing an interactive media, comprising:
providing a computing system with at least one processing device and at least one memory device, wherein the computing system executes computer-readable instructions, and a network connection operatively connecting at least one user device and the computing system, the network connection configured to permit network data flow between the at least one user device and the computing system, and wherein the at least one user device is configured to wirelessly communicate with the computing system via an interactive media application;
receiving input data related to an end user, via a graphical user interface of the at least one user device and the interactive media application;
generating a customized end user specific interactive media based upon the input data; and
displaying the customized end user specific interactive media on a graphical user interface of at least one end user device.

20. A method for customizing an interactive media, comprising:
displaying at least one query related to personal data of an end user on a graphical user interface of a user device;
receiving input data related to the personal data of the end user via the graphical user interface of the user device;
displaying at least one query related to an end user specific interactive media experience on the graphical user interface of the user device;
receiving input data related to the end user specific interactive media experience via the graphical user interface of the user device;
displaying at least one query related to an end user specific occasion and/or event on the graphical user interface of the user device;
receiving input data related to the end user specific occasion and/or event via the graphical user interface of the user device;
displaying at least one query related to an end user specific theme on the graphical user interface of the user device;
receiving input data related to the end user specific theme via the graphical user interface of the user device;
displaying at least one query related to one or more end user specific characters on the graphical user interface of the user device;
receiving input data related to the one or more end user specific characters via the graphical user interface of the user device;
displaying at least one query related to one or more end user specific challenges on the graphical user interface of the user device;
receiving input data related to the one or more end user specific challenges via the graphical user interface of the user device;
generating, via at least one processing device of a computing system, a customized end user specific interactive media based upon the input data received; and
displaying the customized end user specific interactive media on a graphical user interface of at least one end user device.
